(19) United States
(12) Patent Application Publication
(10) Pub. No.: US 2004/0256489 A1
(43) Pub. Date: Dec. 23, 2004

(54) Sprinkler and root feeder assembly

(76) Inventors: John E. Grady, Lombard, IL (US); William Mitchell, Villa Park, IL (US)

Correspondence Address: AUSTIN J. FOLEY, Esq., WALLENSTEIN WAGNER & ROCKEY, LTD, 53rd Floor, 311 South Wacker Drive, Chicago, IL, 60606-6630, US

(21) Appl. No.: 10/811,067

(22) Filed: Mar. 26, 2004

Related U.S. Application Data
(60) Provisional application No. 60/458,513, filed on Mar. 28, 2003.

(51) Int. Cl. B05B 7/04

(52) U.S. Cl. 239/398

(57) ABSTRACT

A sprinkler and root feeder assembly (10) is provided comprising a housing (12) defining a first chamber (18) and a second chamber (20), a first fluid inlet (22) in communication with the first chamber (18) and adapted to be connected to a source of pressurized fluid and a first outlet (26) adapted to be connected to a sprinkling unit (14) and in communication with the first chamber (18). Also included is a second fluid inlet (28) in communication with the second chamber (20) and adapted to be connected to a source of pressurized fluid and a second outlet (32) adapted to be connected to a root feed unit (16) and in communication with the second chamber (20), wherein the first chamber (18) and the second chamber (20) are adapted to receive a water soluble chemical.

### CROSS REFERENCE TO RELATED APPLICATIONS

This application claims priority from U.S. Provisional Patent Application Ser. No. 60/458,513, filed on Mar. 28, 2003.

### TECHNICAL FIELD

The present invention relates to a fluid mixing and dispensing device. More particularly, it relates to a sprinkler and root feeder assembly permitting a single assembly to be used as a foliage sprinkler, or root feeder or both simultaneously.

### BACKGROUND OF THE INVENTION

Sprinkling systems and devices as well as irrigation systems and devices for use by the consumer and on a commercial basis, have been in existence for a number of years. Traditionally, a sprinkler or irrigation system provides for above ground watering or dispensing of fertilizers, herbicides, pesticides or other useful chemicals in a spray application. Alternatively, root feeding devices are also known. Such devices typically include a nozzle inserted into the ground through which fertilizers or other chemicals are fed directly to the root system.

While numerous devices are described in the prior art for separately sprinkling or root feeding, there remains a need for a single device, of simple construction and use, capable of either or both sprinkling and root feeding. The present invention provides for convenient execution of a foliage treatment (sprinkling) or a root treatment for trees, shrubs, and other plants, using plain water or including a mixture of selected chemicals, in a single device. As a sprinkler, the device supplies a rain-like liquid application over a large area, encouraging natural absorption by grass, gardens, shrubs, trees and other foliage. As a root feeder, a hollow tube is insertable into the ground, both securing the device in place, and supplying the roots with an effective application of water, or of a solution of chemicals and nutrients.

Chemicals that are suitable and desirable for sprinkling applications are typically not suitable, and may even be harmful, for root feeding applications. The opposite is true, as well. Therefore, a need exists for a device or assembly that permits both or either sprinkling and root feeding, while essentially eliminating the possibility of mixing sprinkling fertilizer with root feed fertilizer, or accidently using one in place of the other.

The present invention is provided to solve these and other problems.

### SUMMARY OF THE INVENTION

It is an object of the present invention to provide a sprinkler and root feeder assembly.

The assembly includes a housing defining a first chamber and a second chamber; a first fluid inlet in communication with the first chamber and adapted to be connected to a source of pressurized fluid; and a first outlet adapted to be connected to a sprinkling unit and in communication with the first chamber. A second fluid inlet is also included and is in communication with the second chamber and adapted to be connected to a source of pressurized fluid. A second outlet is adapted to be connected to a root feed unit and is in communication with the second chamber, wherein the first chamber and the second chamber are adapted to receive a water soluble chemical.

In another aspect of the invention, the assembly further includes a water impregnable barrier separating the first chamber from the second chamber.

In another aspect of the invention, the assembly further includes a feed inlet in communication with the first chamber for passage of the water soluble chemical. The feed inlet is adapted to be selectively sealed.

In another aspect of the invention, the assembly further includes a second feed inlet in communication with the second chamber for passage of the water soluble chemical. The second feed inlet is adapted to be selectively sealed.

In another aspect of the invention, the assembly further includes a feed inlet in communication with the second chamber for passage of the water soluble chemical. The feed inlet for the second chamber is also adapted to be selectively sealed.

In another aspect of the invention, the first fluid inlet comprises a first arm member extending from the housing and having a connector for connecting to a source of pressurized fluid.

In another aspect of the invention, the second fluid inlet comprises a second arm member extending from the housing and having a connector for connecting to a source of pressurized fluid.

In another aspect of the invention, the second fluid inlet comprises an arm member extending from the housing and having a connector for connecting to a source of pressurized fluid.

In another aspect of the invention, the first arm member extends from the housing in a direction generally opposite the direction in which the second arm member extends from the housing.

### BRIEF DESCRIPTION OF THE DRAWINGS

FIG. 1 is a perspective view of one embodiment of the sprinkler and root feeder assembly-of the present invention;

FIG. 2 is a perspective view of the housing of the embodiment of FIG. 1;

FIG. 3 is a lower perspective view of the housing of the embodiment of FIG. 1;

FIG. 4 is a side elevation view of an insertion tip;

FIG. 5 is a front perspective view of the insertion tip; and

FIG. 6 is rear perspective view of the interior of the insertion tip.

### DETAILED DESCRIPTION

While this invention is susceptible of embodiment in many different forms, there are shown in the drawings and will herein be described in detail, preferred embodiments of the invention with the understanding that the present disclosures are to be considered as exemplifications of the principles of the invention and are not intended to limit the broad aspects of the invention to the embodiments illustrated.

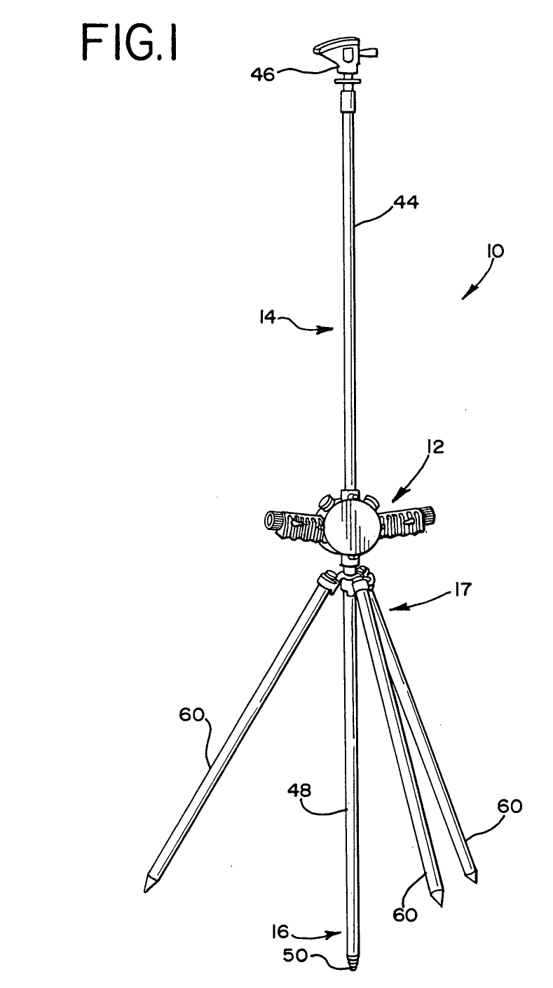

As shown in FIG. 1, the sprinkler and root feeder assembly 10 of one embodiment of the present invention includes a housing 12, a sprinkler unit 14, a root feeder unit 16 and a support unit 17.

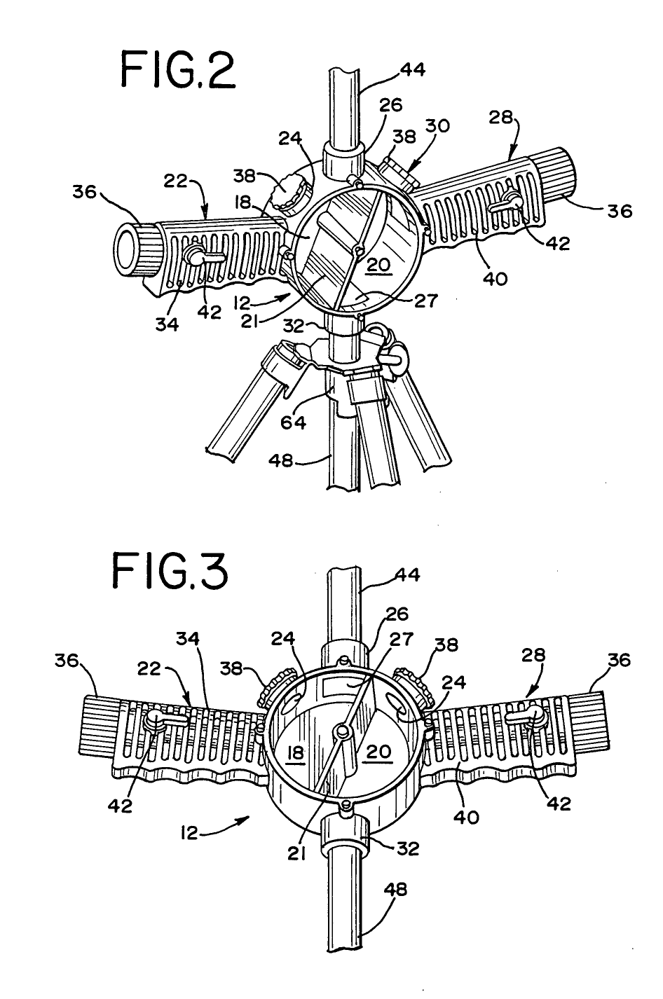

The housing 12 (FIGS. 2-3) defines a first chamber 18 and a second chamber 20. A water impermeable wall or other barrier 21 separates the first chamber 18 from the second chamber 20. The housing 12 also includes a first fluid inlet 22, a first feed inlet 24, a first outlet 26, a second fluid inlet 28, a second feed inlet 30 and a second outlet 32.

The first fluid inlet 22 is in flow communication with the first chamber 18 and is adapted to be connected to a source of pressurized fluid, such as water. The first fluid inlet 22 comprises a first arm member 34 that defines a first flow path (not shown) in flow communication with the first chamber 18 at one end and with a threaded connector 36 at another end. The threaded connector 36 is adapted for connection with a standard garden hose. The first feed inlet 24 is in communication with the first chamber 18 and includes a removable feed cap 38 for sealing the inlet 24. The cap 38 may be threaded, or may use any other known means, such as snap fitting, for closing and sealing the inlet 24. The first outlet 26 is also in communication with the first chamber 18 and is adapted to be connected to the sprinkler unit 14, to be described. A screen 27 (FIG. 3) is located within the first chamber 18 and across the first outlet 26. The first arm member 34 also includes a flow valve 42 for opening and closing the first flow path.

The second fluid inlet 28 is in flow communication with the second chamber 20 and is adapted to be connected to a source of pressurized fluid, such as water. The second fluid inlet 28 comprises a second arm member 40 that defines a second flow path (not shown) in flow communication with the second chamber 20 at one end and with a second threaded connector 36 at another end for connection to a standard garden hose. The second feed inlet 30 is in communication with the second chamber 20 and includes a removable feed cap 38 for sealing the second feed inlet 30. The cap 38 may be threaded, or may use any other known means, such as snap fitting, for closing and sealing the inlet 30. The second outlet 32 is also in communication with the second chamber 20 and is adapted to be connected to the root feeder unit 16, to be described. The second arm member 40 also includes a flow valve 42 for opening and closing the second flow path. A screen 27 is located within the second chamber 20 and across the second outlet 32.

The first arm member 34 and the second arm member 40 extend radially from that portion of the housing 12 defining the first and second chambers 18,20 and in generally opposite directions from one another. The first arm member 34 and second arm member 40 are each configured for gripping by the human hand and serve as a handle for the assembly 10.

The sprinkler unit 14 comprises a riser tube 44 and a sprinkler head 46. The riser tube 44 is connected at one end to the first outlet 26 of the housing 12 by any known connection means. Another end of the riser tube is connected to a sprinkler head 46. The sprinkler head 46 shown is a standard “spike” type impulse sprayer. However, any of a multitude of known sprinkler head types could be utilized while remaining within the scope of the invention. The riser tube 44 has a hollow interior and is in flow communication with the first outlet 26 and sprinkler head 46. Accordingly, a flow path is formed from, by and through the first inlet 22, the first chamber 18, the first outlet 26, the riser tube 44 and the sprinkler head 46.

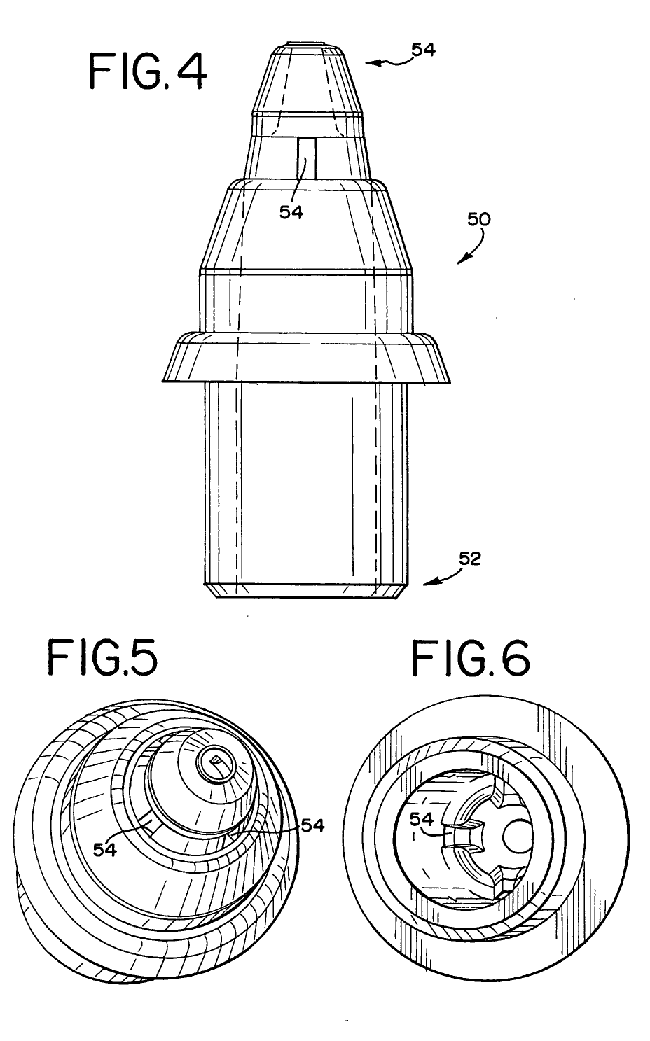

The root feeder unit 16 comprises an insertion tube 48 and a delivery tip 50. The insertion tube 48 is connected at one end to the second outlet 32 of the housing 12 by any known connection means. The delivery tip 50 is connected to the other end of the insertion tube 48. The delivery tip 50 (FIGS. 4-6) is hollow and generally cylindrically shaped. At a proximal end 52, the tip 50 is cylindrical and configured for connection to an end of the insertion tube 48. At a distal end 54, the tip 50 is generally conical to facilitate its insertion into the ground proximate to a root system.

The tip 50 includes a series of a plurality of discharge orifices 56 located about the periphery of the distal end 54. The orifices 56 are in communication with the hollow interior of the delivery tip 50. Accordingly, a flow path is formed from, by and through the second inlet 28, the second chamber 20, the second outlet 32, the insertion tube 48, the delivery tip 50 and the orifices 56.

The support unit 17 can be any of many known support units or structures such as the tripod-type support unit 17 shown in the figures.

To use the sprinkler and root feeder assembly 10, a user would grasp the fully assembled sprinkler and root feeder assembly 10 by the first arm member 34 and the second arm member 40. After positioning the assembly 10 in the general area wished to be treated, the user would insert the delivery tip 50 and insertion tube 48 into the ground by pushing down on the arm members 34, 40.

Once the assembly 10 is properly positioned, if the user wishes to sprinkle and feed foliage, the user attaches a standard garden hose to the connector 36 of the first arm member 34. Typically, the valve 42 should be in the off position when this is done. The main water valve to the garden hose may then be opened to pressurize the hose with water. The assembly 10 may be used to fertilize or feed the foliage. Foliage feed or fertilizer, in the form of a water soluble chemical, may be utilized for sprinkling by removing the cap 38 from the first feed inlet 24. The foliage fertilizer is then inserted into the first chamber 18 and the cap 38 replaced to seal the inlet 24. The foliage fertilizer is typically in the form of water soluble pellet, but other forms may be used as is known in the industry.

Once the feed has been inserted into the first chamber 18 and the first feed inlet 24 has been sealed, the valve 42 may be moved to the on position, opening the first fluid inlet 22 and allowing the pressurized water to flow through the assembly 10. The water flows through the threaded connector 36, through the first arm member 34 and into the first chamber 18 where it contacts and begins to dissolve the water soluble chemical. The water and chemical mixture then exits the first chamber 18 through the first fluid outlet 26 and flows through the riser tube 44 and is sprayed out of the sprinkler head 46 to water and feed any surrounding foliage.

If the user wishes to feed a root system in the vicinity of the assembly 10, the user attaches a standard garden hose to the threaded connector 36 of the second arm member 40. With the valve 42 of the second arm member 40 in an off position, the main valve to the garden hose may be opened to pressurize the hose with water. To feed a root system, the user would then remove cap 38 from the second feed inlet 30 and insert a water soluble chemical suitable for feeding a root system and then replace the cap 38 to reseal the feed inlet 30. Again, this root fertilizer is typically in the form of a water soluble chemical pellet, but other forms may be used as is known in the industry.

Once the root fertilizer has been inserted into the second chamber 20 and the second feed inlet 30 has been sealed, the valve 42 may be moved to the on position, opening the second fluid inlet 28 and allowing the pressurized water to flow through the assembly 10. The water flows through the threaded connector 36, through the second arm member 40 and into the second chamber 20 where it contacts and begins to dissolve the root fertilizer. The water and chemical mixture then exits the second chamber 20 through the second fluid outlet 32 and flows through the insertion tube 48 and out of the delivery tip 50. The water and chemical mixture is then dispersed through the plurality of orifices 56 in the delivery tip 50 to water and feed the surrounding root system. Of course, the assembly 10 can be used without any feed or fertilizer as either a sprinkler or root feeder.

In this way, it can be seen that the above described embodiment of the invention may be used to either sprinkle/feed surrounding foliage, or water/feed a surrounding root system. Additionally, both foliage and root sprinkling/feeding can be accomplished simultaneously through the use of two garden hoses. Furthermore, a number of alternatives to the above described embodiment can be utilized while remaining within the scope of the present invention.

For example, a single chamber may be used rather than first and second chambers 18, 20. In such an embodiment, the barrier or wall 21 would not be present. However, a valve, similar to valves 42, may be included in each of the first and second fluid outlets 26 and 32. In this way, either sprinkling, root feeding, or both can be selected by opening and closing these valves. Also, since only a single chamber would be utilized in such an embodiment, only a single fluid inlet and feed inlet would be needed. However, the second arm member 40 would still be beneficial for providing a handle means for assisting insertion of the delivery tip 50 into the ground.

An embodiment may be contemplated without any feed inlets 24, 30. This embodiment could be effective for only watering foliage or roots. Or it could also be adapted for feeding. In such a case the first and/or second fluid outlets could also be adapted for insertion of fertilizer when their respective riser and feed tubes are removed or disconnected. Alternatively, the inlets could be adapted for insertion of the feed into the appropriate chamber.

Also, any length riser tube 44 or type of sprinkler head 46 could be utilized while remaining within the scope of the present invention. Any length insertion tube 48 could be utilized so long as its length is adapted to cooperate with the support unit 17 to allow sufficient penetration of the delivery tip 50 into the ground. Furthermore, the support unit 17 may be dispensed of entirely. In this case, it is desirable to ensure the insertion tube 48 is of sufficient strength to provide the sole means of support to the assembly 10.

The housing 12 is constructed of any material of suitable strength. The housing 12 may be molded as a single piece, or may be comprised of a plurality of pieces or moldings welded or otherwise appropriately joined. For example, the housing 12 could be manufactured in halves, and glued, welded or otherwise joined generally along a line defined by the wall 21 of the above described embodiment.

Any of these embodiments, as well as others, may be utilized while remaining within the scope of the present invention.

While the specific embodiments have been illustrated and described, numerous modifications come to mind without significantly departing from the spirit of the invention and the scope of protection is only limited by the scope of the accompanying Claims.

What is claimed is:

1. A sprinkler and root feeder assembly comprising:
a housing defining a first chamber and a second chamber;
a first fluid inlet in communication with the first chamber and adapted to be connected to a source of pressurized fluid;
a first outlet adapted to be connected to a sprinkling unit and in communication with the first chamber;
a second fluid inlet in communication with the second chamber and adapted to be connected to a source of pressurized fluid; and
a second outlet adapted to be connected to a root feed unit and in communication with the second chamber.

2. The assembly of claim 1 wherein at least one of the first chamber and the second chamber is adapted to receive a water soluble chemical.

3. The assembly of claim 1 further comprising a water impregnable barrier separating the first chamber from the second chamber.

4. The assembly of claim 2 further comprising a feed inlet in communication with the first chamber for passage of the water soluble chemical and adapted to be selectively sealed.

5. The assembly of claim 4 further comprising a second feed inlet in communication with the second chamber for passage of the water soluble chemical and adapted to be selectively sealed.

6. The assembly of claim 2 further comprising a feed inlet in communication with the second chamber for passage of the water soluble chemical and adapted to be selectively sealed.

7. The assembly of claim 1 wherein the first fluid inlet comprises a first arm member extending from the housing and having a connector for connecting to a source of pressurized fluid.

8. The assembly of claim 7 wherein the second fluid inlet comprises a second arm member extending from the housing and having a connector for connecting to a source of pressurized fluid.

9. The assembly of claim 1 wherein the second fluid inlet comprises an arm member extending from the housing and having a connector for connecting to a source of pressurized fluid.

10. The assembly of claim 8 wherein the first arm member extends from the housing in a direction generally opposite the direction in which the second arm member extends from the housing.

11. A sprinkler and root feeder assembly comprising:
a housing comprising:
a first chamber defined by the housing and having a first inlet adapted to be connected to a source of pressurized fluid and having a first outlet; and
a second chamber defined by the housing and having a first inlet adapted to be connected to a source of pressurized fluid and having a second outlet;
a sprinkler unit comprising a riser tube and a sprinkler head, wherein the riser tube is connectable to the first outlet at a first end of the riser tube and connectable to the sprinkler head at a second end of the riser tube; and
a root feeder unit comprising an insertion tube connectable to the second outlet at a first end of the insertion tube and a delivery tip for delivering fluid to a root system at a second end of the insertion tube.

12. The assembly of claim 11 wherein at least one of the first chamber and the second chamber is adapted to receive a water soluble chemical.

13. The assembly of claim 11 wherein the first inlet comprises a first arm member extending from the housing defining a first path in communication with the first chamber at one end of the flow path and in communication with a connector for connecting to a source of pressurized fluid at another end of the first flow path.

14. The assembly of claim 13 wherein the second inlet comprises a second arm member extending from the housing defining a second flow path in communication with the second chamber at one end of the second flow path and in communication with a connector for connecting to a source of pressurized fluid at another end of the second flow path.

15. The assembly of claim 1 1 wherein the second inlet comprises an arm member extending from the housing defining a flow path in communication with the second chamber at one end of the flow path and in communication with a connector for connecting to a source of pressurized fluid at another end of the flow path.

16. The assembly of claim 14 wherein the first arm member extends from the housing in a direction generally opposite the direction in which the second arm member extends from the housing.

17. The assembly of claim 11 further comprising a support unit having mounting means for mounting the support unit to the insertion tube at substantially any point along a length of the insertion tube and a plurality of support legs, each support leg connected at an end thereof to the mounting means.

18. The assembly of claim 17 wherein the mounting means comprises a bracket having a ring portion configured to slidingly engage the riser tube, a threaded thumb screw extendable through the ring portion for frictional engagement with the riser tube, and a plurality of extension members extending from the ring portions for connecting to an end of a support leg.

19. The assembly of claim 17 wherein the plurality of support legs comprises three support legs.

20. The assembly of claim 18 wherein the plurality of support legs comprises three support legs.

21. A sprinkler and root feeder assembly comprising:
a housing defining a chamber;
a fluid inlet in communication with the chamber;
a sprinkling outlet having a flow control valve moveable between an open position and a closed position, the sprinkling outlet being in communication with the chamber and adapted to be connected to a sprinkler unit; and
a fluid outlet having a flow control valve moveable between an open position and a closed position, the feed outlet being in communication with the chamber and adapted to be connected to a root feed unit;
wherein the chamber is adapted to receive a water soluble chemical.

22. The assembly of claim 21 further comprising a feed inlet in communication with the chamber for insertion of a water soluble chemical into the chamber, the feed inlet adapted to be selectively sealed.

23. The assembly of claim 21 wherein the fluid inlet comprises an arm member extending from the housing defining a flow path in communication with the chamber at one end and in communication with a connector for connecting to a source of pressurized fluid at another end of the flow path.
